(19) United States
(12) Patent Application Publication
(10) Pub. No.: US 2005/0152755 A1
(43) Pub. Date: Jul. 14, 2005

(54) Laser device for helping an intended point on a work piece located exactly opposite the sharp point of a drill

(76) Inventors: Sean Chen, Taipei (TW); Eric Lo, Taichung (TW); George Ku, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/756,321

(22) Filed: Jan. 14, 2004

(51) Int. Cl. B23B 49/00

(52) U.S. Cl. 408/16

(57) ABSTRACT

A laser device includes a securing ring, a supporting ring, and two laser modules; the securing ring is secured around a tube of a drilling machine, which has a transmission shaft projecting from the tube, and a drill joined to the transmission shaft; the securing ring has threaded holes thereon, and adjustment bolts projecting out from the threaded holes; the supporting ring is joined to the securing ring by means of bolts, and touches the adjustment bolts; the laser modules are fitted to the supporting ring for emitting laser lights capable of forming an intersection on a work piece positioned opposite the supporting ring, thus helping the work piece to be adjusted in position such that an intended point on the work piece is exactly faced with the shape point of the drill.

### BACKGROUND OF THE INVENTION

1. Field of the Invention

The present invention relates to a laser device for helping a drill of a drilling machine directed at an intended point of a work piece, more particularly one, which can emit laser lights forming an intersection on a work piece positioned under it, and which can be easily adjusted in position for the laser light intersection to be exactly opposite the sharp point of the drill.

2. Brief Description of the Prior Art

Referring to FIG. 7, a conventional drilling machine has a support base 11, a support rod 12 joined to the base 11, and a table 13 supported on the support rod 12 for a work piece 100 to be positioned thereon. Fixing jaws 19 are disposed on the table 12 for fixing the work piece 100 in position. A power source 14 is disposed above the table 12, and a tube 10 is provided, which projects downwards from the power source 14. A transmission shaft (not numbered) is held within, and projects downwards from the tube 10. A drill chunk 15 is joined to the lower end of the transmission shaft, and a drill 16 is secured to the chunk 15. A control unit, which includes a handle 18 and a shaft 17, is fitted to the power source 14 for making the drill 16 move up and down when being operated.

In order for helping a drill to be directed at the intended position of a work piece before a hole is drilled, the work piece is usually first formed with a recess mark at the intended position by means of a centering punch, and then the operator moves, while watching both the drill and the recess mark carefully, the work piece on the table 13 for adjusting the position of the recess mark relative to the drill 16 before fixing the work piece in position with the jaws 19. A centering drill can be first joined to the chunk 15, and used to make a shallow hole on the intended position of a work piece instead of a centering punch, and is then replaced with a second drill such that a hole can be formed on the work piece with the second drill.

Either one of the above methods will cost the operator much labor and time. Consequently, the cost of production is increased.

### SUMMARY OF THE INVENTION

It is a main object of the present invention to provide a laser device, which can help direct a drill of a drilling machine at an intended point of a work piece, to overcome the above disadvantages.

The laser device of the present invention includes a securing ring, a supporting ring, and two laser modules. The securing ring is secured around the tube of the above drilling machine, from which the transmission shaft projects. The securing ring has threaded holes thereon, and adjustment bolts projecting out from the threaded holes. The supporting ring is joined to the securing ring by means of bolts, which are inserted through aligned through holes of both of the rings, and screwed into a respective nut. The supporting ring touches first ends of the adjustment bolts after being joined to the securing ring. The laser modules are fitted to the supporting ring for emitting laser lights capable of forming an intersection on a work piece positioned on a table of the drilling machine under the supporting ring. Thus, with the help of the intersection of the laser lights, the work piece can be adjusted in position such that an intended point thereon is exactly faced with the shape point of the drill.

### BRIEF DESCRIPTION OF THE DRAWINGS

The present invention will be better understood by referring to the accompanying drawings, wherein:

FIG. 1 is an exploded perspective view of the laser device of a drilling machine according to the present invention,

FIG. 2 is a perspective view of the laser device according to the present invention,

FIG. 3 is a partial perspective view of a drilling machine with the laser device of the present invention,

FIG. 4 is a partial vertical section of the laser device of the present invention, fitted to a drilling machine,

FIG. 5 is a side view of a drilling machine with the laser device of the present invention in operation,

FIG. 6 is a top view of the laser device of a drilling machine according to the present invention, and

FIG. 7 is a front view of the conventional drilling machine.

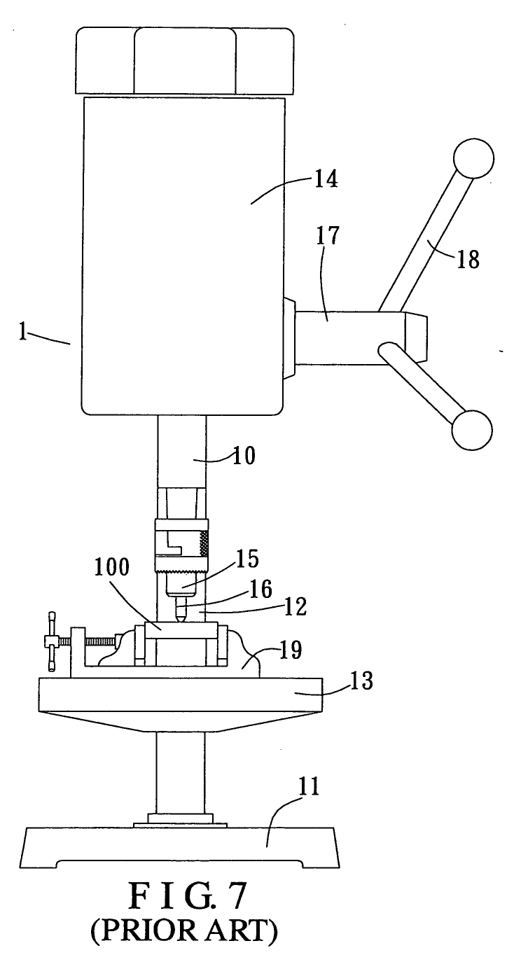

### DETAILED DESCRIPTION OF THE PREFERRED EMBODIMENTS

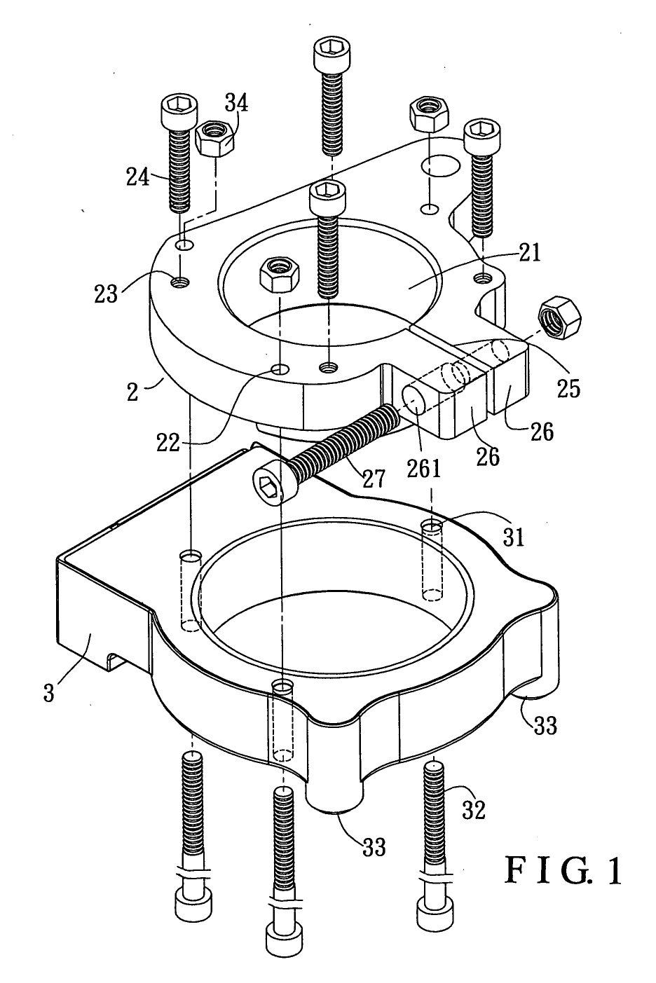

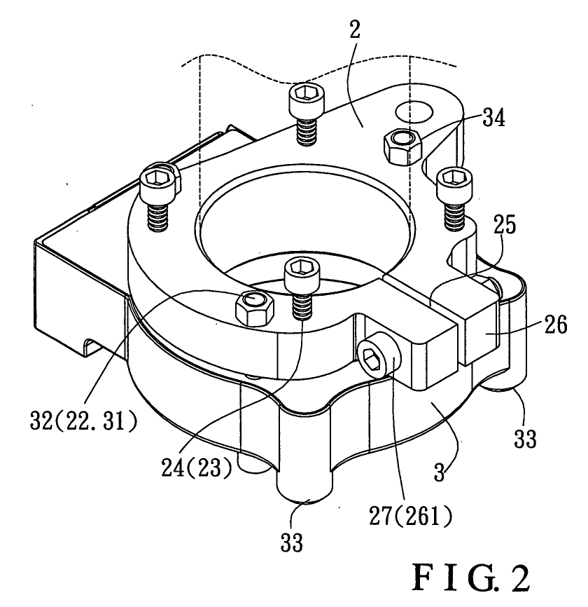

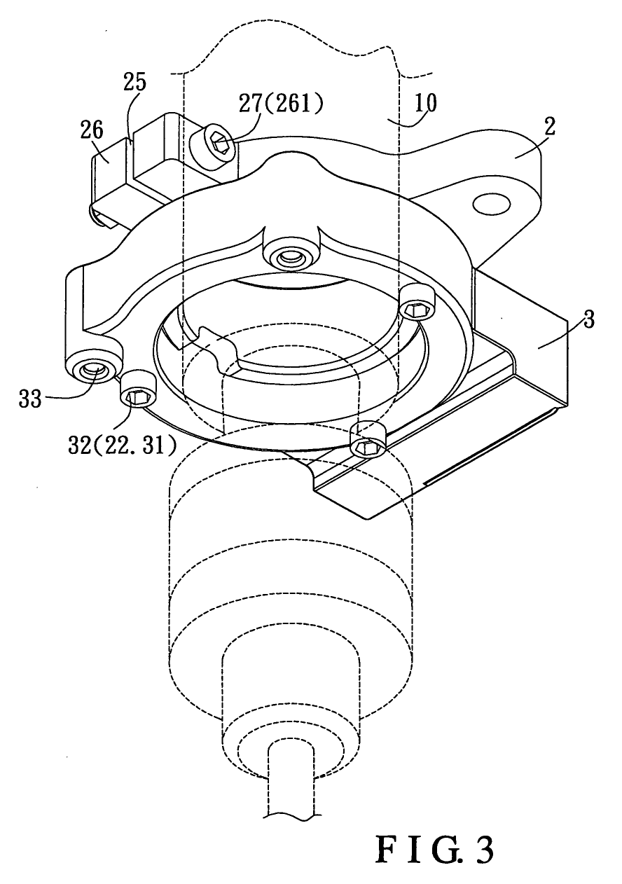

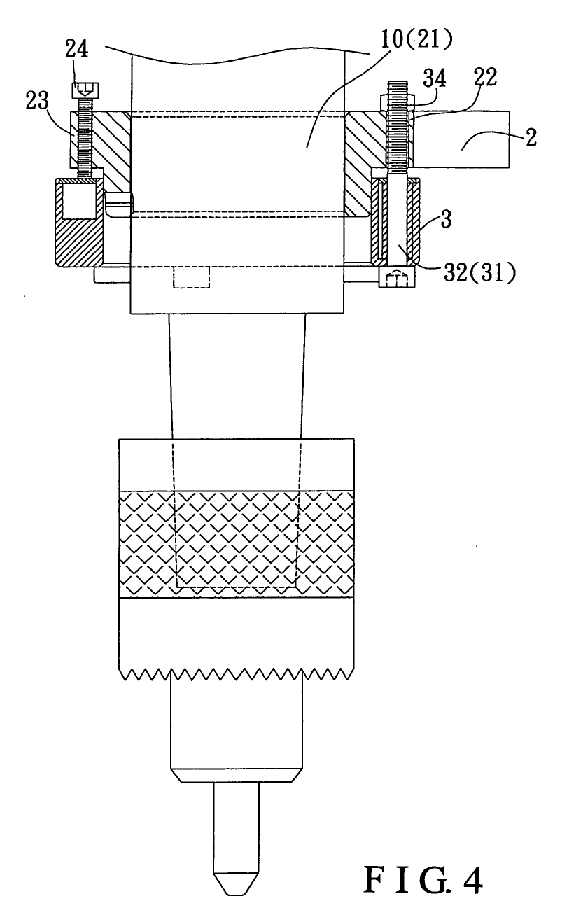

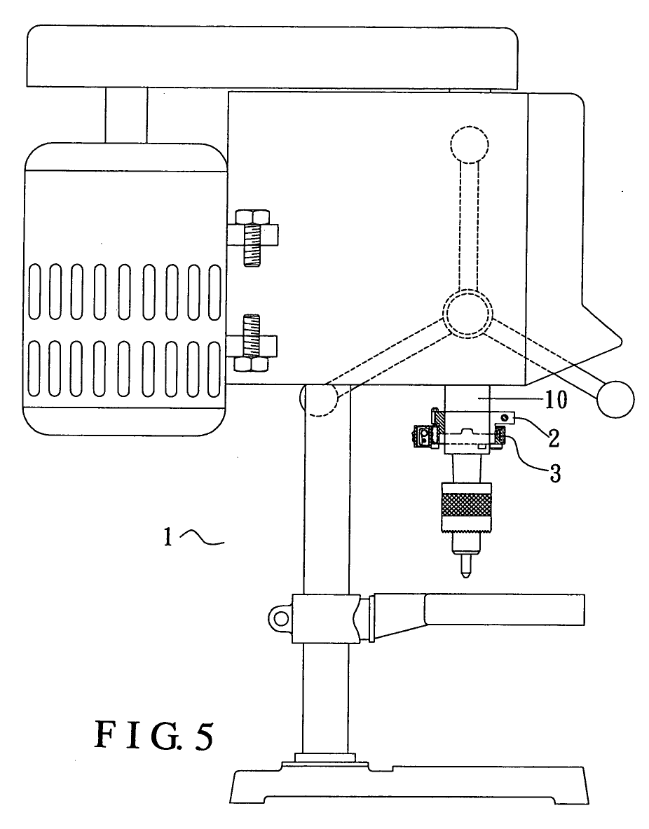

Referring to FIGS. 1 to 5, a preferred embodiment of a laser device in the present invention includes a securing ring 2 secured around the tube 10 of the drilling machine 1 as described in the Background above, a supporting ring 3 arranged under and joined to the securing ring 2, and a pair of laser modules 33 fitted to the supporting ring 3.

The securing ring 2 has a middle space 21, several through holes 22, several threaded adjustment holes 23, a gap 25, two securing projections 26 on two sides of the gap 25, and aligned connecting holes 261 on the securing projections 26. The securing ring 2 is positioned around the support tube 10, and then secured to the same by means of passing a threaded connecting element 27 through the aligned connecting holes 261, and tightly screwing the element 27 into a nut (not numbered).

The supporting ring 3 has several through holes 31 thereon, and is positioned around the support tube 10 under the securing ring 2 with the through holes 31 being aligned with a respective through hole 22. The supporting ring 3 is joined to the securing ring 2 by means of passing threaded connecting elements 32 through the through holes 31 and 22, and screwing the threaded elements 32 into nuts 34.

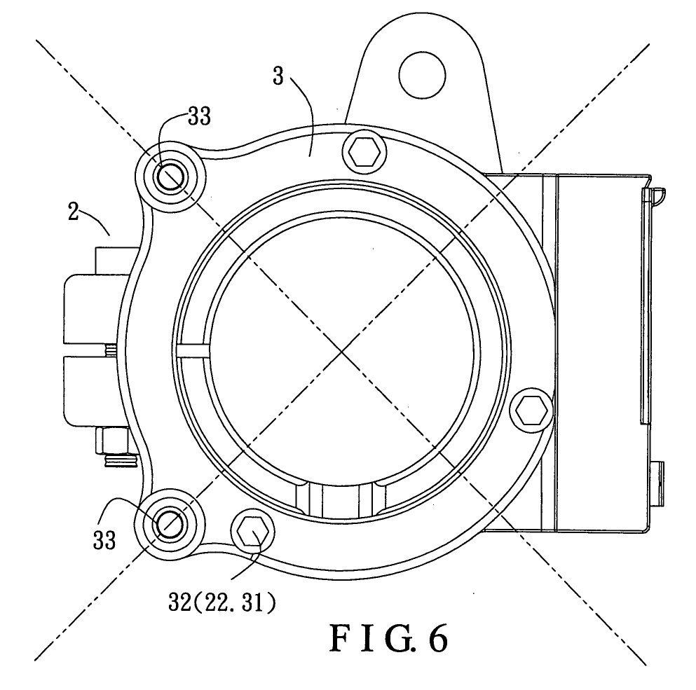

The laser modules 33 are located on a lower side of the supporting ring 3, and can emit laser lights, which will form an intersection on a work piece positioned under the supporting ring 3, as shown in FIG. 6.

In addition, adjustment bolts 24 are screwed into, and project out from, the adjustment holes 23 such that the supporting ring 3 will come into contact with the lower ends of the adjustment bolts 24 after it is firmly joined to the securing ring 2. Therefore, orientation of the supporting ring 3 relative to the securing ring 2 plus the drill 16 can be adjusted with the help of the adjustment bolts 24 and the threaded connecting elements 32.

Furthermore, in order for allowing the supporting ring 3 to be effectively adjusted in position with ease, the number of the through holes 22 on the securing ring 2 is preferably three, and that of the threaded adjustment holes 23 four.

Before the laser device is used, the supporting ring 3 is adjusted in position relative to the tube 10 of the drilling machine 1 with the help of the adjustment bolts 24 as well as the threaded connecting elements 32 such that the light intersection formed on a plane located opposite the lower side of the supporting ring 3 is exactly faced with the shape point of the drill 16.

In using the drill machine to drill a hole on an intended point of a work piece, the work piece is positioned on the table 13 of the drilling machine 1, and adjusted in position until the intended point of the work piece is at the same position as the laser light intersection formed by the laser lights of the laser modules 33. Thus, the drill 16 is directed at the intended point of the work piece, and a hole will be formed exactly on the same after the drill 16 is used.

From the above description, it can be easily understood that the laser device of a drilling machine in the present invention has advantages as followings:
1. With the present laser device, the operator of a drilling machine can make an intended point of a work piece exactly faced with the sharp point of the drill with ease. Consequently, labor and time are saved.
2. The orientation of the supporting ring 3 relative to the securing ring 2 can be easily adjusted with the help of the adjustment bolts 24 and the threaded connecting elements 32. Therefore, it is easy for the operator to adjust the supporting ring 3 and the laser modules 33 in position such that the laser light intersection formed on a plane located opposite the lower side of the supporting ring 3 is exactly faced with the shape point of the drill 16. In other words, the present laser device is convenient to use.

1. A laser device for helping a work piece adjusted in position relative to a drill of a drilling machine, comprising
a securing ring secured around a tube of a drilling machine, which has a transmission shaft projecting from the tube, and a drill joined to the transmission shaft; the securing ring having a plurality of through holes, and a plurality of threaded holes thereon; each threaded hole having an adjustment bolt screwed therein and projecting out from it; the securing ring having a gap, and two projections on two sides of the gap; the projections having aligned holes; the securing ring being secured to the support tube with a threaded element being inserted through the aligned holes of the projections, and screwed into a nut;
a supporting ring having through holes thereon; the supporting ring being positioned around the support tube and touching first ends of the adjustment bolts with the through holes thereof being aligned with a respective through hole of the securing ring; the supporting ring being secured in position by means of bolts inserted through respective through holes and screwed into a respective nut; and
a pair of laser modules fitted to the supporting ring for emitting laser lights capable of forming an intersection on a work piece located opposite the supporting ring; the supporting ring being positioned in such a way that the laser light intersection on the work piece is exactly opposite a sharp point of the drill.

2. The laser device as claimed in claim 1, wherein number of the threaded holes of the securing ring is four.

3. The laser device as claimed in claim 1, wherein number of the through holes of the securing ring is three.
